(19) United States
(12) Patent Application Publication
(10) Pub. No.: US 2026/0287153 A1
(43) Pub. Date: Sep. 24, 2026

(54) MODULAR STACKABLE LIGHT FIXTURE

(71) Applicant: 3form, LLC, Salt Lake City, UT (US)

(72) Inventors: Dax K. Pettibone, American Fork, UT (US); Ryan G. Smith, Seattle, WA (US); Guillaume Martin, Rochetoirin (FR)

(21) Appl. No.: 18/445,685

(22) Filed: Mar. 18, 2025

(51) Int. Cl. F21V 17/10; F21V 1/00; F21V 17/06

(52) U.S. Cl. CPC F21V 17/105; F21V 1/00; F21V 17/06

(57) ABSTRACT

The modular stackable light fixtures of the present invention includes collars, shades, and diffusers that enable users to construct or reconfigure cost-effective modular light fixtures. A modular light fixture can include a collar with one or more indexes and a shade with a neck that contains one or more magnets. The neck features receiving elements that engage with the indexes, and the magnets retain the shade and collar in a locked orientation. The shades can have various geometries and may include baffles, inner shells, and coupling elements.

### CROSS-REFERENCE TO RELATED APPLICATIONS

N/A.

### BACKGROUND OF THE INVENTION

### 1. Technical Field The present invention pertains to modular, stackable lighting systems.

### 2. Background and Relevant Art

Conventional lighting systems often feature static designs that limit customization and adaptability. These systems may include fixed lamp shades that do not allow for easy replacement or modification, which can be problematic for users seeking to update their decor or repair damaged components. Additionally, traditional lamp shades and lighting systems may rely on mechanical fasteners or adhesives that can be cumbersome to assemble and disassemble, potentially leading to wear and tear over time.

Furthermore, conventional lighting systems typically lack modularity, meaning users cannot easily change the appearance or functionality of their lamps. This rigidity can be a significant drawback for those who desire a more dynamic, personalized lighting solution. The materials used in traditional lamp shades may also be limited in variety, restricting the range of aesthetic and functional effects that can be achieved.

Overall, these limitations highlight the need for more innovative lighting solutions that offer greater flexibility, ease of assembly, and customization options.

Accordingly, there are a number of difficulties in the art of lighting fixtures that can be addressed.

### BRIEF SUMMARY OF THE INVENTION

Implementations of the present invention comprise systems, methods, and apparatus related to modular lighting fixtures. In particular, implementations of the present invention can comprise collars, shades, and diffusers that enable a user or assembler to construct or reconfigure cost-effective modular light fixtures that align with aesthetic and functional design goals.

A modular light fixture can comprise a collar having one or more indexes and a shade having a neck wherein the neck comprises one or more magnets. The neck can comprise one or more receiving elements for engaging with the one or more indexes. The magnets can retain the shade and collar within a locked orientation.

A shade for use in modular light fixtures can comprise one or more baffles having an interior edge, an outer edge, and an inner shell. The shade may also include a neck that defines a first opening and comprises one or more receiving elements. The outer edge of the one or more baffles can form an outermost perimeter of the shade. A portion of the inner shell can abut the interior edge of the one or more baffles. Additionally, one or more magnets can be embedded into the neck.

A collar for use in modular light fixtures can comprise a body having an upper surface and a lower surface and one or more walls that extend from the lower surface of the body. The collar may also include one or more apertures that extend through the body and one or more indexes that extend from the one or more walls.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a modular light fixture of the present disclosure;

FIG. 1B illustrates a cluster of modular light fixtures of the present disclosure;

FIG. 2A illustrates a cylindrical totem shade of the present disclosure;

FIG. 2B illustrates a cross-sectional view of the cylindrical totem shade of FIG. 2A;

FIG. 3A illustrates a perspective view of a saucer pendant shade of the present disclosure;

FIG. 3B illustrates a cross-sectional view of the saucer pendant shade of FIG. 3A;

FIG. 4A illustrates a top-perspective view of a collar of the present disclosure;

FIG. 4B illustrates a bottom perspective view of the collar of FIG. 4A;

FIG. 4C illustrates a bottom plan view of the collar of FIG. 4A;

FIG. 4D illustrates a side cross-sectional view of the collar of FIG. 4A;

FIG. 5A illustrates a top-perspective view of a collar of the present disclosure;

FIG. 5B illustrates a bottom perspective view of the collar of FIG. 5A;

FIG. 5C illustrates another bottom perspective view of the collar of FIG. 5A;

FIG. 5D illustrates a side plan view of FIG. 5C;

FIG. 5E illustrates a different side cross-sectional view of the collar of FIG. 5A;

FIG. 6A illustrates a totem light fixture of the present disclosure;

FIG. 6B illustrates another embodiment of a totem light figure of the present disclosure;

FIG. 7A illustrates a nested light fixture of the present disclosure;

FIG. 7B illustrates another embodiment of a nested light fixture of the present disclosure;

FIG. 8 illustrates a diffuser of the present disclosure; and

FIG. 9 illustrates a sequence of inserting a film into a diffuser of the present disclosure.

### DETAILED DESCRIPTION OF THE PREFERRED EMBODIMENTS

The present invention extends to systems, methods, and apparatus related to modular lighting fixtures. In particular, implementations of the present invention can comprise collars, shades, and diffusers that enable a user or assembler to construct or reconfigure cost-effective modular light fixtures that align with aesthetic and functional design goals.

Accordingly, the present disclosure relates to modular light fixtures for use in public and private spaces. Specifically, the present disclosure provides modular light fixtures with removable shades and collars configured for tool-less locking and assembly. Users of modular light fixtures of the present disclosure will appreciate the configurability and customizability of the modular light fixtures as they allow a user or assembler to assemble or reconfigure the modular light fixture cheaply. For example, the collars of the present disclosure allow for the support of one or more shades that a manufacturer can construct into various shapes, patterns, or designs, which users can select from to suit a specific design aesthetic or functional purpose.

Users can assemble or reconfigure modular light fixtures of the present disclosure through the magnetic twist lock design disclosed herein. A user can insert a collar into the neck of a shade and twist it relative to the shade to engage elements of the collar with elements of a shade's neck. This twisting engagement process alone allows a collar to support and secure a shade. Magnets embedded within the collar and the neck of the shade can advantageously provide a retention force that can dissuade the collar and shade from disengaging from one another.

Manufacturers of modular light fixtures of the present disclosure can construct shades, collars, and diffusers from Polylactic Acid (PLA), Polyethylene Terephthalate Glycol (PETG), Acrylonitrile Butadiene Styrene (ABS), Polycarbonate (PC), Thermoplastic Polyurethane (TPU), Polyvinyl Alcohol (PVA), Polyethylene (PE), or a similar material. Manufacturers may also construct shades, collars, and diffusers from metals, alloys, woods, composites, rubbers, etc. A manufacturer can choose the material based on the specific aesthetic or function design goal they have in mind for the modular lighting fixture. For example, PLA can be used in a 3D printer to produce components with a smooth finish that provides a sleek and clean aesthetic. Alternatively, PETG can be selected for its durability and flexibility characteristics.

The manufacturer can choose a colored material or utilize colored inserts within the diffuser to change the perceived color of the light output by the modular light fixtures.

While the present disclosure teaches hanging light fixtures, the modular light fixtures can be configured to reside on tables, floors, and walls. Additionally, the modularity of the modular light fixtures allows a user to easily disassemble and reassemble the light fixtures for regular cleanings without having to undergo a complex disassembly process.

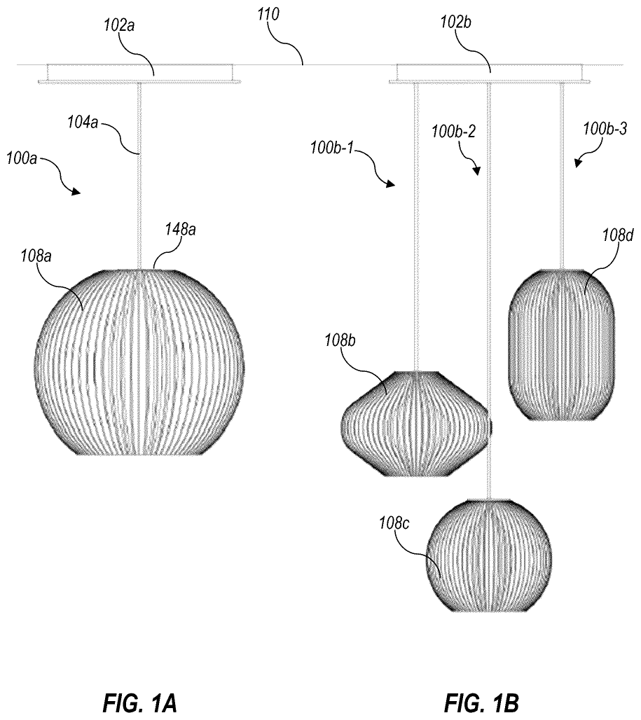

FIG. 1A illustrates a modular light fixture 100a. Light fixture 100a can include base 102a, support 104a, collar 148a, and shade 108a. Base 102a can secure to a ceiling or similar support surface 110 and act as an anchor point from which an assembler can secure or hang shade 108a. Base 102a can have a power supply or requisite wiring harness(es) to enable the passage of power from a power source into a light source within shade 108a. Base 102a may sit flush with the support surface 110 or extend outwards and away from the support surface 110. Should base 102a not sit flush with support surface 110, base 102a can extend into a cavity or space defined at least partially by support surface 110.

FIG. 1A shows that support 104a can couple base 102a with a collar 148a. Support 104a can be a hollow tube, cable, or similar member with sufficient strength to support the weight of one or more shades 108 and any added lighting hardware. Support 104a can secure base 102a and collar 148a together through one or more fasteners, threaded elements, indexed elements, or similar securing means. In at least one embodiment, support 104a can include one or more swivel elements or can couple to one or more swivel elements disposed on base 102a or collar 148a. The swivel elements can enable the mounting of base 102a on a non-level support surface or allow for the positional adjustment of shade 108a relative to base 102a. A user will appreciate the adjustability and versatility of support 104a as a user can utilize support 104a to install light fixture 100a into an existing space without commissioning a bespoke fit light fixture. Additionally, support 104a can include telescoping or extending portions along its length to allow for the tool-less expansion or contraction of its overall length. Similarly, one or more supports 104a can selectively couple to one another to vary the overall length.

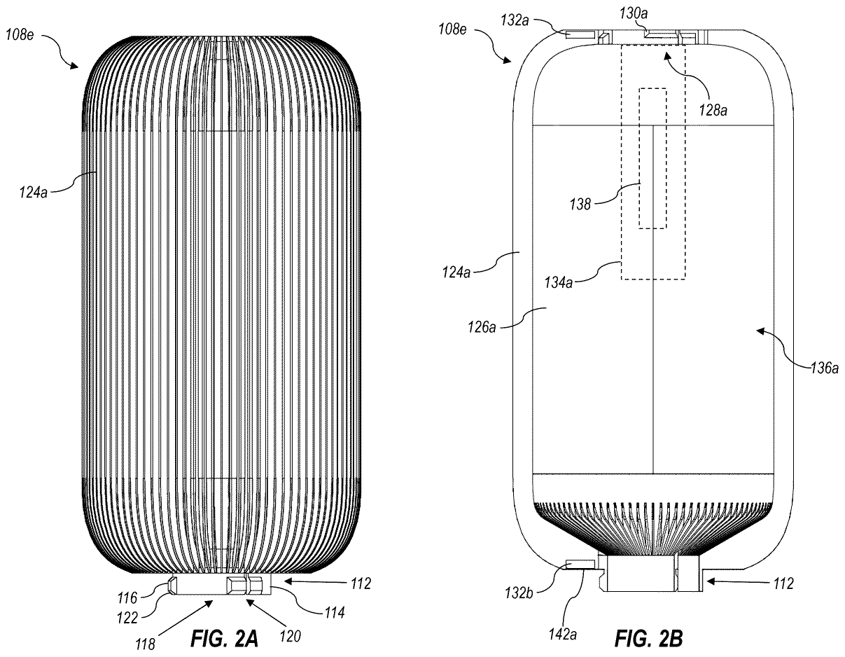

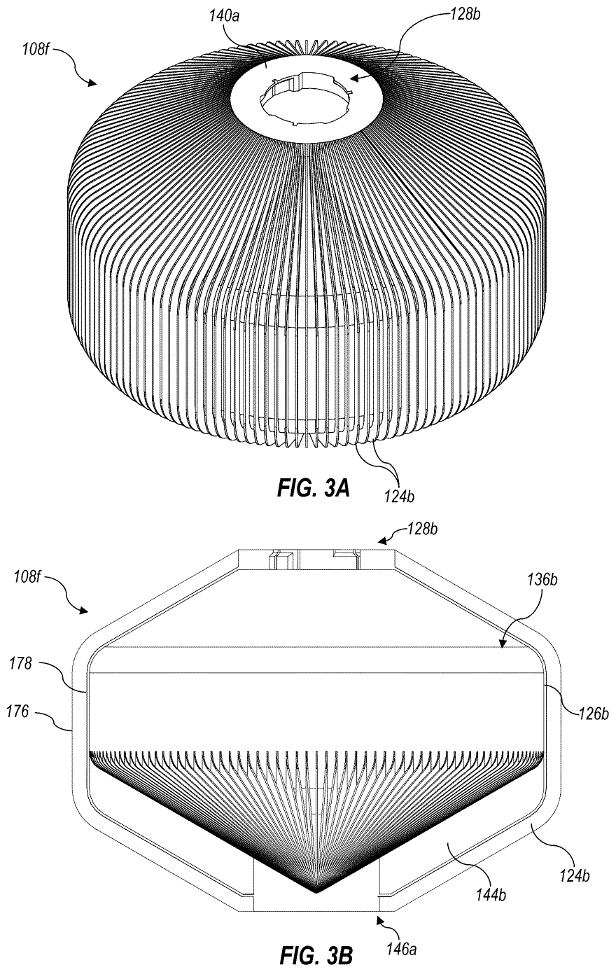

FIG. 1A shows collar 148a selectively coupled to shade 108a. Shade 108a has a substantially spherical geometry. As shown throughout the disclosure, shades 108 can have various geometries. Shades 108 of the present disclosure may also be a totem, a pendant, or an open bottom shade. Being a totem means the shade can selectively couple to one or more other shades. Being a pendant means the shade can have a closed lower region. Being open bottom means the shade can have an opening in its lower region. FIGS. 2A, 3A, and 7A show these features.

FIG. 1B illustrates a light fixture cluster 100b of modular light fixtures 100b-1, 100b-2, and 100b-3. Base 102b can support cluster 100b. Base 102b can have one or more apertures or connection elements to secure one or more light fixtures 100b-1, 100b-2, and 100b-3. Cluster 100b can support shades 108b, 108c, and 108d at heights or distances relative to base 102b. In another embodiment, an assembler can install shades 108b, 108c, and 108d at the same height or distance from base 102b. For example, a user may want a linear row of lights and can install shades 108b, 108c, and 108d such that they are side by side in a row.

FIG. 2A illustrates a cylindrical totem shade 108e. As previously discussed, totem shade 108a can couple to one or more additional shades by way of connection element 112. Connection element 112 can include one or more walls 114 and one or more indexes 116. For example, totem shade 108e can have three walls 114 that define an opening 118. Opening 118 can be circular. Opening 118 can enable the passage of wiring, lights, or other components of a modular light fixture through one shade and into another. A manufacturer can include a space 120 between each of the walls 114 to enable the indexing or coupling to corresponding features of another shade or collar of the present disclosure. Walls 114 can extend outwards and away from shade 108e and provide a surface where a manufacturer can install one or more indexes 116.

FIG. 2A shows that index 116 can be a protrusion from the surface of wall 114. Index 116 can enable an assembler to secure one shade to another. Index 116 can interrelate with the corresponding elements on another shade (illustrated in FIG. 2B). Index 116 can have one or more chamfered or angled sides 122 or an overall tapered shape. These angled sides 122 or overall tapered shape allows an assembler to easily lock one shade to another by twisting the totems about their vertical axis and aiding in the alignment of index 116 to the corresponding elements of the other shade.

FIG. 2A shows totem shade 108e, which has an overall cylindrical shape with rounded ends. Totem shade 108e can have one or more baffles 124a. A manufacturer can dispose baffles 124a on the outer surface of totem shade 108e. Baffles 124a can have a length equivalent to the overall length of totem shade 108e and can define the visual shape of totem shade 108e. Baffles 124a can protrude or extend from an inner shell 126a (shown in FIG. 2B). Baffles 124a can have a thickness, and a manufacturer can space baffles 124a apart at a set interval or random interval around the outer surface of the inner shell 126a.

FIG. 2B illustrates a cross-sectional view of the cylindrical totem shade 108e of FIG. 2A. Inner shell 126a can be multipart or monolithic in construction. For example, a manufacturer can extrude or additively print (i.e., 3D print) shades of the present disclosure. In such a case, a manufacturer can advantageously construct a multipart inner shell 126a and not have to use a large or oversized printer or extruder. Baffled 124a can be independent elements so that they clip together or to the inner shell 126a. In another embodiment, a manufacturer adheres baffles 124a to the inner shell 126a. In at least one embodiment, totem shade 108e is monolithic in construction, and the manufacturer extrudes, prints, or constructs totem shade 108e as a single piece.

FIG. 2B illustrates that totem shade 108e has neck 128a. Neck 128a can define an opening configured for receiving a collar of the present disclosure or a coupling element 112 of another totem shade. Neck 128a can have receiving elements 130a disposed around the circumference of its opening, which are corresponding features that interrelate with index 116 (shown in FIG. 2A). Receiving elements 130a can be tapered or chamfered, similar to indexed 116. The tapering or chamfering enables an assembler to easily twist one or more shades together or a shade and a collar such that receiving element 130a and index 116 lock together.

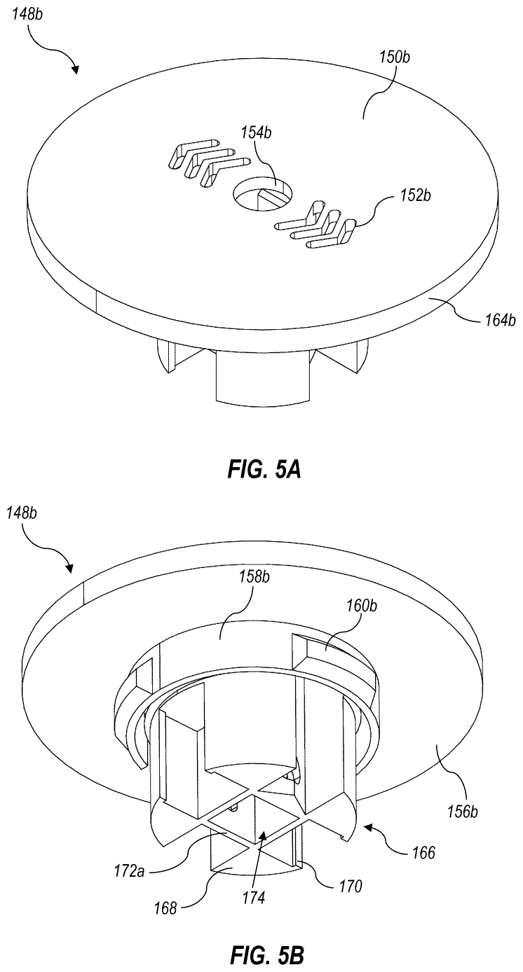

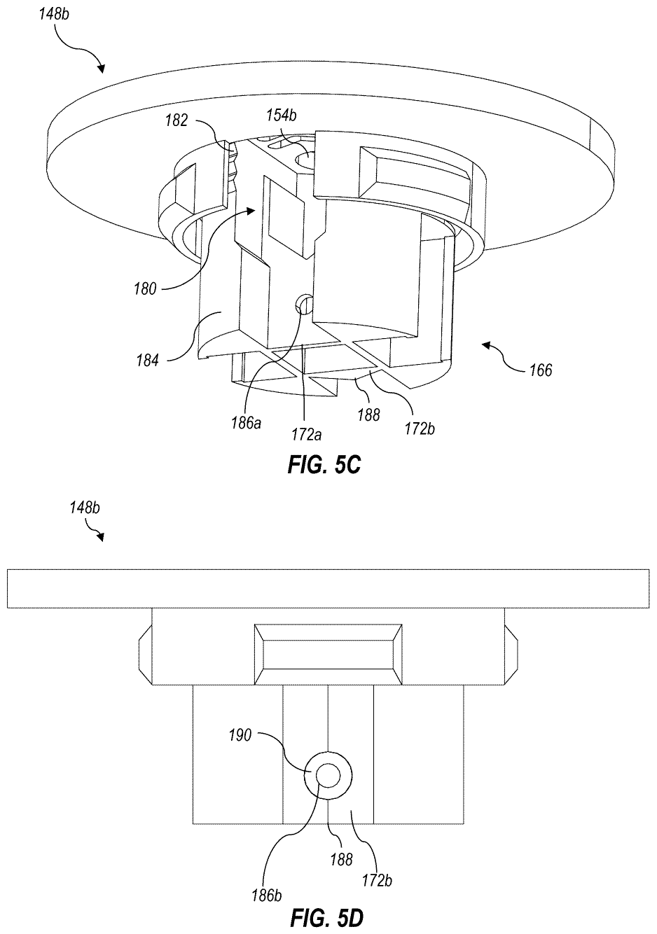

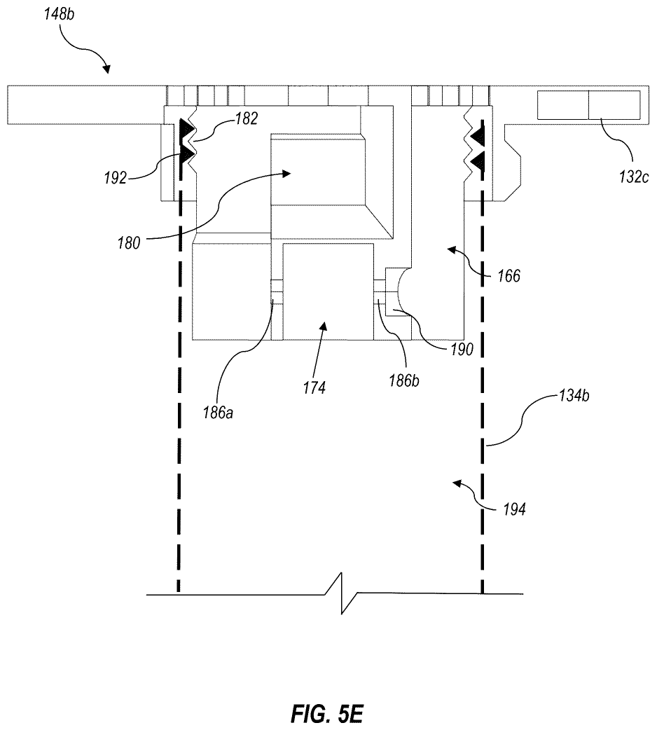

FIG. 2B shows that neck 128a can include one or more compartments 132a. A manufacturer can include one or more compartments 132a around the circumference of the neck 128a at predefined or random intervals. For example, a manufacturer can install the magnets equally spaced around the opening defined by neck 128a. Compartment 132a can receive a magnet configured to assist in locking a collar of the present disclosure or coupling element of another shade in place once an assembler twists them together. Accordingly, collars of the present disclosure can be inherently magnetic or include one or more magnetic elements that can couple to the magnets in compartments 132a. (See compartment 132c in FIG. 5E). Similarly, coupling element 112 can be inherently magnetic or can include one or more magnetic elements embedded within or on its surfaces. For example, a compartment 132b near coupling element 112 may retain a magnet. Totem shade 108e may further include a bottom surface 142a that can be substantially flat or level to align with the upper surface of a different totem shade.

FIG. 2B illustrates that a diffuser 134a can reside within an internal cavity 136a defined by an inner shell 126a. Diffuser 134a can couple to a collar of the present disclosure or directly to neck 128a. For example, an assembler can twist and lock the diffuser 136a into neck 120, similar to how a collar or coupling element is secured. Diffuser 134a can include a light element 138 and wiring. The light element can extend for the length of the diffuser 134a or for only a portion of the length of the diffuser 134a. Similarly, a manufacturer can install light element 138 centered within diffuser 134a or at a specific position within diffuser 134a. Light element 138 can be any form of light, such as LED, incandescent, halogen, compact fluorescent lights, or similar. Diffuser 134a can allow for a power source's quick connection or disconnection to the light element 138 inside. For example, pins or pads can be present on the outer surface of the diffuser 134a to allow for a contact-based connection with wiring connected to a power source. Diffuser 134a can be transparent or semi-transparent to allow for the transmission of light from light element 138 to a viewer outside of shade 108e.

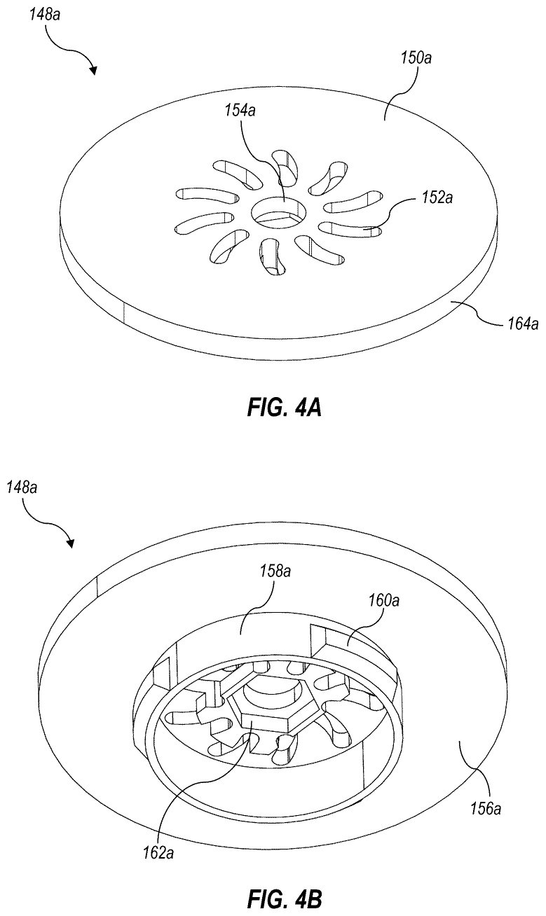

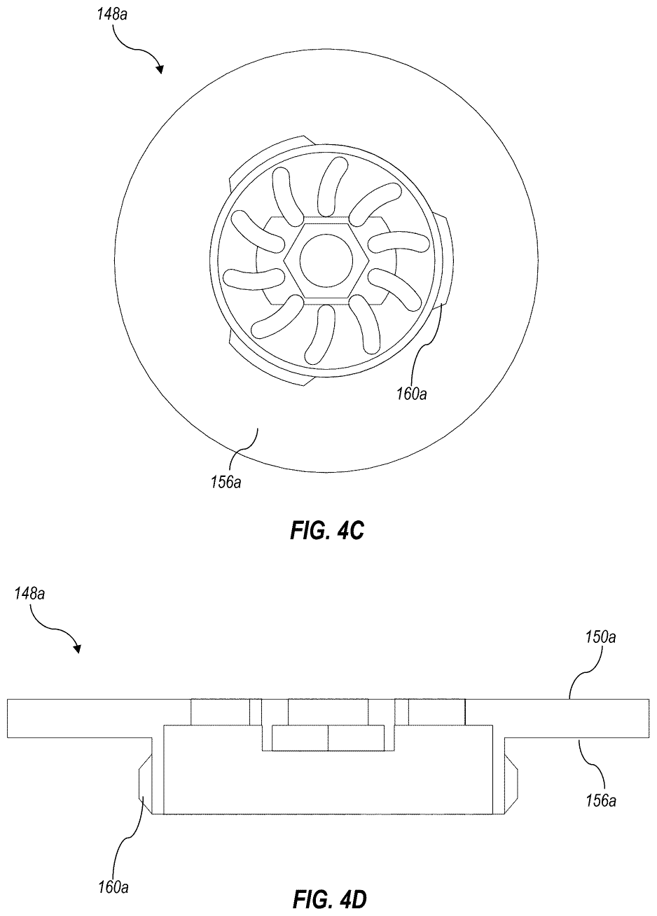

FIG. 3A illustrates a perspective view of saucer pendant shade 108f. As previously discussed, a pendant shade can be a closed bottom shade, thus unable to couple with multiple additional shades. Pendant shade 108f can include one or more baffles 124b and a neck 128b. Neck 128b can include an upper surface 140a configured for abutting a bottom surface 142a or 156a (shown in FIG. 2B or 4B). As previously mentioned, an assembler can embed one or more magnets within the neck 128b. The substantially flat nature of upper surface 140a can enable the one or magnets to better interface with a magnetic collar or magnets disposed in a bottom surface 142a of a shade (seen in FIG. 2B). An assembler will appreciate that in at least one embodiment, the magnets embedded in the upper surface 140a and bottom surface 142a (seen in FIG. 2B) are positioned such that they interface together when the two shades are twisted and locked into place. The magnets can then provide a retention force to dissuade the shades from un-twisting or unlocking.

FIG. 3B illustrates a cross-sectional view of the saucer pendant shade 108f of FIG. 3A. Shades 108 of the present disclosure can have internal baffles 144a. In at least one embodiment, internal baffle 144a and external baffle 124b are monolithic and are one contiguous member. In such an embodiment, inner shell 126b may not extend across the entire internal cavity 136b. Accordingly, apertures that pass from outside the pendant shade 108f to the internal cavity 136b may be defined by the space between each baffle 124b and by the space between each baffle 144a (should they be present).

Alternatively, as shown in FIG. 3B, inner shell 126b can extend to define the entire internal cavity and divide internal baffles 144a from baffles 124b. Internal baffles 144a can increase the overall rigidity and structural soundness of pendant shade 108f. Pendant shade 108f can have a bottom portion 146a that is closed. In one embodiment, the bottom portion 146a can be transparent or semi-transparent, while in another embodiment, the bottom portion 146a can stop all transmission of light. Similarly, inner shell 126b, baffles 124b, and internal baffles 144b can be transparent or semi-transparent or configured to stop all transmission of light. A manufacturer can vary which components allow light transmission to accomplish various functional and aesthetic outcomes.

FIG. 3B shows baffles 124b having an outer edge 176 and an interior edge 178. The outer edges 176 of baffles 124b can define an outer perimeter of shade 108f. Interior edge 178 can abut the inner cavity 136b or inner shell 126b.

In another embodiment, a shade may not have any baffles. Rather, the shade may have a textured or complex geometry such as waves, folds, creases, ridges, bumps, etc. In such an embodiment, the shade may have only a singular layer of material that defines the outer and inner surfaces. Alternatively, multiple layers of material can define the outer and inner surfaces of the shade. In such an embodiment, internal baffles may or may not be present. For example, a manufacturer may use a single layer of material with ridges and valleys (or folded creases) that provide a visual aesthetic similar to the aesthetic provided by the baffles disclosed herein.

FIG. 4A illustrates a top-perspective view of collar 148a. Collar 148a can include an upper surface 150a, apertures 152a, and aperture 154a. Upper surface 150a can be substantially circular. In another embodiment, upper surface 150a can take a different geometric shape, such as a square or triangle. Upper surface 150a can define one or more apertures 152a and 154a. Apertures 152a can allow for the passage of warm air that may build up inside a shade to which the collar 148a is secured. Aperture 154a can selectively couple to supports of the present disclosure (see FIG. 1A) and allow for the passage of wires or cables from outside of a shade into a shade. Additionally, a diffuser or light element may selectively couple with apertures 152a and/or 154a using one or more fasteners. For example, an assembler may secure a light element configured for throwing light directionally (i.e. downwards toward the ground) to collar 148a (or any other collar of the present disclosure).

A manufacturer can construct collar 148a from a similar material to the shades of the present disclosure. In at least one embodiment, collar 148a can be constructed from a material with magnetic properties. A manufacturer can also embed one or more magnets into body 164a so that collar 148a and a shade of the present disclosure can magnetically interface and resist de-coupling.

FIG. 4B illustrates a bottom perspective view of collar 148. Collar 148a can further comprise wall 158a (analogous to wall 114) and indexes 160a (analogous to index 116). Together, wall 158a and indexes 160a form an element analogous to connection element 112, allowing an assembler to couple collar 148a to the neck of a shade. Collar 148a can also include recess 162a, enabling the coupling or securing of a diffuser or light element.

FIG. 4C illustrates a bottom plan view of collar 148a, and FIG. 4D illustrates a side cross-sectional view of collar 148a. These figures illustrate that collar 148a can include three equally spaced indexes 160a. Indexes of the present disclosure can extend radially outward.

FIG. 5A illustrates a top-perspective view of collar 148b. Similar to collar 148a, collar 148b can include an upper surface 150b, apertures 152b and 154b, and body 164b. Upper surface 150b can be substantially circular. In another embodiment, upper surface 150b can take a different geometric shape, such as a square or triangle. Upper surface 150b can define one or more apertures 152b and 154b. Apertures 152b can allow for the passage of warm air that may build up inside a shade to which the collar 148b connects. Aperture 154a can selectively couple to supports of the present disclosure (see support 104a in FIG. 1A) and allow for the passage of wires or cables from outside of a shade into a shade. Collar 148b can couple with shades of the present disclosure.

FIG. 5B illustrates a bottom perspective view of collar 148b. Similar to collar 148a, collar 148b can include wall 158b, indexes 160b, and bottom surface 156b. Collar 148b can also include structure 166. Structure 166 can comprise one or more corners 168. Each corner 168 can have a ridge 170. Ridge 170 can secure componentry inside collar 148b or act as indexes or slots that interface with componentry. Componentry can include lighting elements, wiring, fasteners, portions of shade, tinted material layers, etc. Support structure 166 can also include one or more panels 172a. Panels 172a can define a center opening 174. Center opening 174 can have one or more apertures defined by panels 172a configured to receive fasteners. Center opening 174 can receive a member (e.g. extruded aluminum) that supports a light element positioned within a modular lighting fixture. The member can be secured to support using apertures defined by the support structure 166. (see FIGS. 5C and 5D, apertures 186a and 186b).

FIG. 5C illustrates another bottom perspective view of the collar 148b. FIG. 5C shows passage 180. Passage 180 can be a channel or pathway that connects aperture 154b with the inside of a shade of the present disclosure through structure 166. An assembler can use the angular shape of passage 180 to secure or run needed wiring or cabling to power or control a lighting element. Support 166 may include a thread 182 disposed on a portion of its outer surface 184. Thread 182 enables an assembler to threadingly engage support 166 with a corresponding thread disposed on a diffuser of the present disclosure. A portion of, or the entirety of, support 166 can be received within a diffuser of the present disclosure such that outer surface 184 abuts an inner surface of the diffuser.

FIG. 5C also illustrates aperture 186a, defined by panel 172a. Panel 172a can have an apex 188 that increases the thickness of panel 172a. As shown in FIG. 5D, panel 172b can have an aperture 186b that aligns with aperture 186a.

FIG. 5D illustrates a cross-sectional view of the side plan view of collar 148b. As shown, the added thickness provided by apex 188 allows a manufacturer to provide a countersink 190 such that a fastener head or other member or element can sit flush within countersink 190 when passed through apertures 186a (seen in FIG. 5C) and aperture 186b. Any such fastener, member, or element would partially pass through the space defined by center opening 174.

FIG. 5E illustrates a side cross-sectional view of the collar 148b. Diffuser 134b can have a thread 192 that corresponds to thread 182, which allows an assembler to secure the diffuser 134b to collar 148b. As discussed previously, a portion of the support 166 can be received within space 194, defined by the internal volume of the diffuser 134b.

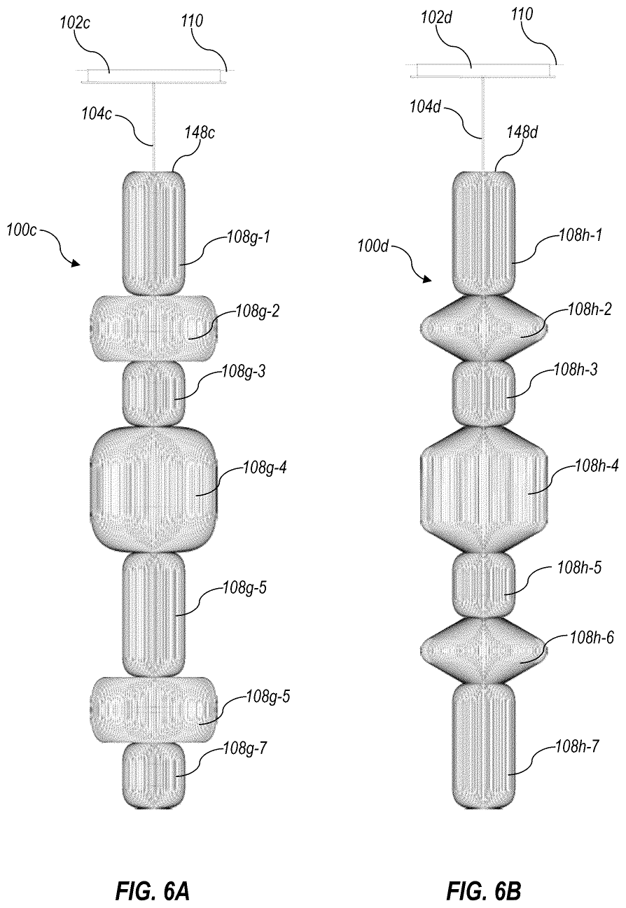

FIG. 6A illustrates a totem light fixture 100c. Light fixture 100c can include base 102c, support 104c, collar 148c, and shades 108g-1, 108g-2, 108g-3, 108g-4, 108g-5, 108g-6, and 108g-6. Each of the shades of light fixture 100c has similar geometric profiles, but their dimensions are scaled differently. For example, shade 108g-5 is long and skinny, while shade 108g-2 is short and wide. All shades in light fixture 100c, however, are substantially cylindrical.

FIG. 6B illustrates another embodiment of a totem light FIG. 100d. Light fixture 100d can include base 102d, support 104d, collar 148d, and shades 108h-1, 108h-2, 108h-3, 108h-4, 108h-5, 108h-6, and 108h-6. Shades 108h-1, 108h-3, and 108h-5, and 108h-7 are substantially cylindrical, while shades 108h-2, 108h-4, and 108h-6 are more angular and have a saucer-like geometric profile. Shades of the present disclosure can have a variety of geometric profiles, and totem light fixtures can combine any number of geometric profiles to accomplish a specific functional or aesthetic design.

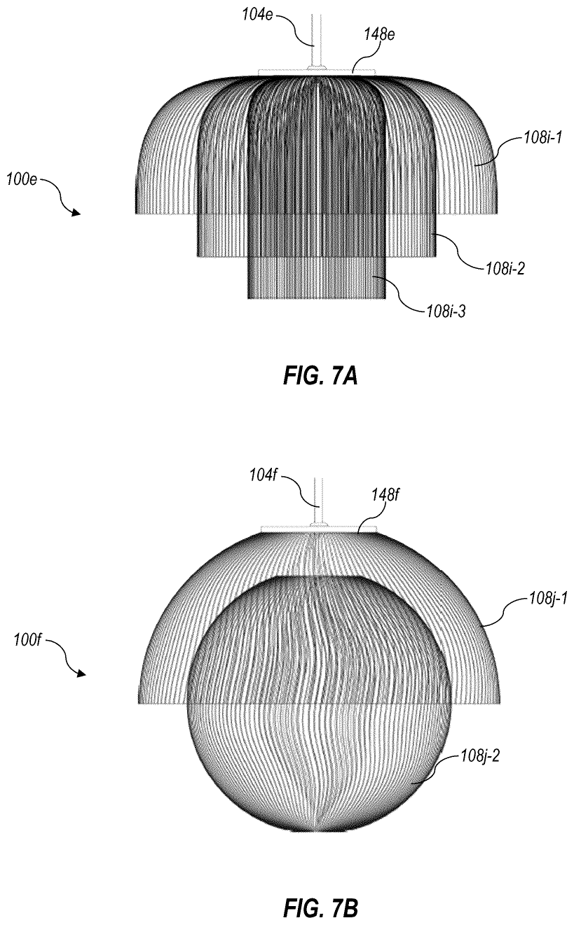

FIG. 7A illustrates a nested light fixture 100e of the present disclosure. Shade 108i-1 can receive a portion of shade 108i-2, and shade 108i-2 can receive a portion of shade 108i-3, resulting in a nested design. Each shade can have an open bottom. In one embodiment, shades 108i-1 can have a coupling element disposed near its neck, that enables an assembler to selectively secure another shade within a portion of its internal volume. Similarly, shades 108i-2, and 108i-3 can have coupling elements disposed near their necks. In yet another embodiment, a collar of the present disclosure can have a plurality of coupling elements to enable a plurality of shades to be coupled to the collar.

FIG. 7B illustrates the nested light fixture 100f of the present disclosure. Shade 108j-1 has an open lower portion capable of receiving a portion of shade 108j-2. Shade 108j-2, however, has a close lower portion. Furthermore, shade 108j-2 is an example of a spherical shade of the present disclosure.

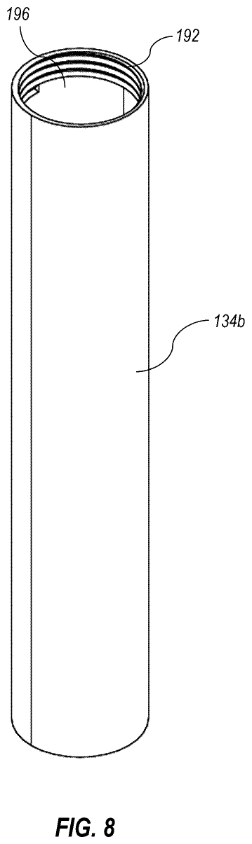

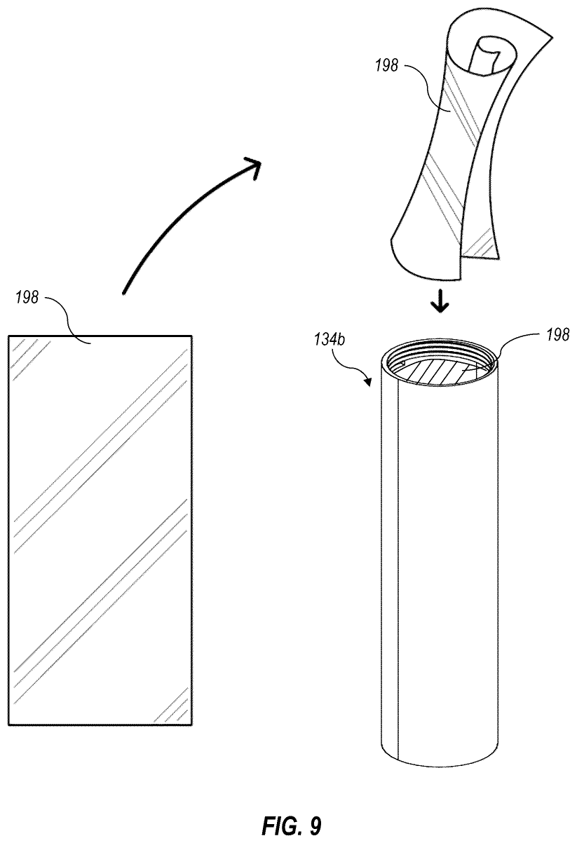

FIG. 8 illustrates diffuser 134b. Diffuser 134b can be substantially cylindrical. Diffuser 134b can have thread 192 disposed on an interior surface 196. Diffuser 134b can allow for the transmission of light through its interior surface 196. A manufacturer can construct a 134b diffuser to any length. The manufacturer can determine the length of diffuser 134b for any aesthetic or functional purpose. For example, the manufacturer can form a shorter diffuser for a shorter shade. The manufacturer may also construct a 134b diffuser from a colored material to produce a colored or tinted light for an end user. In another embodiment, a colored or tinted film can be inserted into diffuser 134b to change the perceived color output of a lighting element that resides inside of diffuser 134b. The film can be pressed against the inner surface 196 by rolling up the film and letting it unfurl inside the diffuser, allowing a user to swap the colors without having to change the diffuser each time. (See FIG. 9).

FIG. 9 illustrates a sequence of inserting film 198 into diffuser 134b. An assembler can first roll or fold film 196. The assembler can then insert film 196 into an opening of diffuser 134b. Once inserted, film 198 is free to unfurl inside diffuser 134b and frictionally retain and conform itself inside the inner surface of diffuser 134b. Film 198 can be a transparent or semi-transparent material. Film 198 can be colored or tinted. Thus, an assembler can use film 198 to allow a modular light fixture with a white light to produce light of varying colors without replacing the lighting element. In another embodiment, a manufacturer can construct diffuser 134b with a colored material to accomplish a similar goal of allowing a white light lighting element to provide a colored light to a user.

The present disclosure teaches innovative modular light fixtures designed for both public and private spaces, emphasizing ease of assembly and customization. The modular design allows users to easily configure and reconfigure the fixtures to suit their aesthetic and functional needs, offering a cost-effective solution for personalized lighting.

Manufacturers and end users can construct these modular light fixtures using various materials through an additive manufacturing or 3D printing process. These processes provide versatility in material choice, allowing for a wide range of design possibilities and ensuring that the fixtures meet diverse aesthetic and functional requirements.

The ability to easily disassemble and reassemble these fixtures for cleaning or reconfiguration is a significant advantage. It enhances the fixtures' longevity and allows users to adapt their lighting to changing needs and preferences. The use of magnets for secure attachment adds a modern touch, ensuring that the components stay in place while still being easy to adjust. Overall, the modular light fixtures of the present disclosure provide a forward-thinking approach to lighting design, combining practicality with aesthetic flexibility.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A modular light fixture comprising:
a collar having one or more indexes; and
a shade having a neck wherein the neck comprises one or more magnets;
wherein:
the neck comprises one or more receiving elements for engaging with the one or more indexes; and
the magnets are configured to retain the shade and collar within a locked orientation.

2. The modular light fixture of claim 1, wherein the collar comprises one or more magnets configured to interface with the magnets within the neck.

3. A shade for use in modular light fixtures comprising:
one or more baffles having an interior edge and an outer edge;
an inner shell; and
a neck that defines a first opening and comprises one or more receiving elements;
wherein:
the outer edge of the one or more baffles forms an outermost perimeter of the shade;
a portion of the inner shell abuts the interior edge of each of the one or more baffles; and
one or more magnets are embedded into the neck.

4. The shade of claim 3, further comprising a coupling element comprising one or more walls and one or more indexes, wherein the coupling element defines a second opening.

5. A collar for use in modular light fixtures comprising:
a body having an upper surface and a lower surface;
one or more walls that extend from the lower surface of the body;
one or more apertures that extend through the body; and
one or more indexes that extend from the one or more walls.

6. The collar of claim 5, further comprising a structure having a threaded portion wherein the structure extends from the lower surface of the body and within a space defined by the one or more walls.

7. A method of assembling a modular lighting fixture claim 1 comprising:
inserting the collar into an opening defined the neck;
twisting the collar relative to the shade;
engaging an index disposed on the collar with a receiving element disposed on the neck of the shade;
engaging a magnet embedded within the collar with a magnet embedded within the neck of the shade.
